(19) United States
(12) Patent Application Publication
(10) Pub. No.: US 2026/0067999 A1
(43) Pub. Date: Mar. 5, 2026

(54) APPARATUS AND METHODS FOR FIXING AN ELECTRIC HEATING WIRE OF AN ELECTRIC HEATING PRODUCT

(71) Applicant: North Star Home LLC, Libertyville, IL (US)

(72) Inventors: Min Zhou, Vernon Hills, IL (US); Xinghua Lin, Shaoxing (CN)

(21) Appl. No.: 18/895,843

(22) Filed: Sep. 25, 2024

(30) Foreign Application Priority Data
Aug. 29, 2024 (CN) 202411202013.7

(51) Int. Cl. H05B 3/34

(52) U.S. Cl. CPC H05B 3/342; H05B 2203/003; H05B 2203/017; H05B 2203/026; H05B 2203/036

(57) ABSTRACT

Apparatus and methods for fixing an electric heating wire of an electric heating product are disclosed herein. An example electric heating product comprises a body; an electric heating wire; a belt defining a passage; and suturing lines. The electric heating wire is wrapped in the passage via the suturing lines, the suturing lines coupling the belt to the body.

### RELATED APPLICATION

This patent claims priority from Chinese Patent Application Number 202411202013.7, which was filed on Sep. 2, 2024, and is hereby incorporated by reference in its entirety.

### FIELD OF THE DISCLOSURE

This disclosure relates to electric heating products, and more particularly, to apparatus and methods for fixing an electric heating wire of an electric heating product.

### BACKGROUND

Electric heating products, such as electric heating blankets are often used for warming purposes in the winter. These products have the advantages of cleanness, convenience, temperature adjustability, and environment-friendly effects.

### BRIEF DESCRIPTION OF THE DRAWINGS

FIG. 1 illustrates an electric heating product in the prior art.

FIG. 2 is a cross-sectional view of portion A of the electric heating product of FIG. 1.

FIG. 3 illustrates an example electric heating product in accordance with teachings of this disclosure and, in particular, shows an exploded view of a body portion of the electric heating product.

FIG. 4 is cross-sectional view of portion A of the electric heating product of FIG. 3 and, in particular, illustrates an example electric wire fixing structure in accordance with teachings of this disclosure.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Electric heating products, such as electric heating padded blankets, are used widely as warming products. Some electric heating products include wearable electric heating products, such as electric covering blankets and electric shawls. Because of wearability, these products are convenient, achieve the thermal function, and are widely popular in cold places such as Europe and the United States.

However, the conversion of an electric heating product to a clothing product introduces different criteria than other types of electric heating products. For instance, a wearable electric heating product may be light weight and provide a comfortable feeling while offering thermal effects and convenience. Additional criteria includes safety performance, cleanability, and clothing performance.

For instance, an electric heating shawl and an electric heating covering blanket are in direct contact with a body of a user and, thus, need to be frequently cleaned. Therefore, water washing resistance of the electric heating product is required, and no deformation and no coil slippage after water washing are also required. The electric heating shawl and the electric heating covering blanket are directly worn on the body, so a user may not treat these wearable items as carefully as he or she would treat an electric heating padded blanket, but rather casually; for example, wearable electric heating products are often moved, folded, kneaded, rolled into a ball, etc. Therefore, the electric heating wire of products such as the electric heating shawl and the electric heating covering blankets may be easily knotted, and a safety accident can easily occur after knotting. To prevent an accident caused by knotting of the electric wire and to ensure the use safety of the electric heating product in industry, a safety control circuit is generally used. If the electric heating wire is knotted, the safety control circuit switches off the power. However, in some such instances, the electric heating product will be scrapped and retired from use by the user, the user may return the goods at any time for this reason, and a loss is born by a manufacturer (e.g., in a guarantee period).

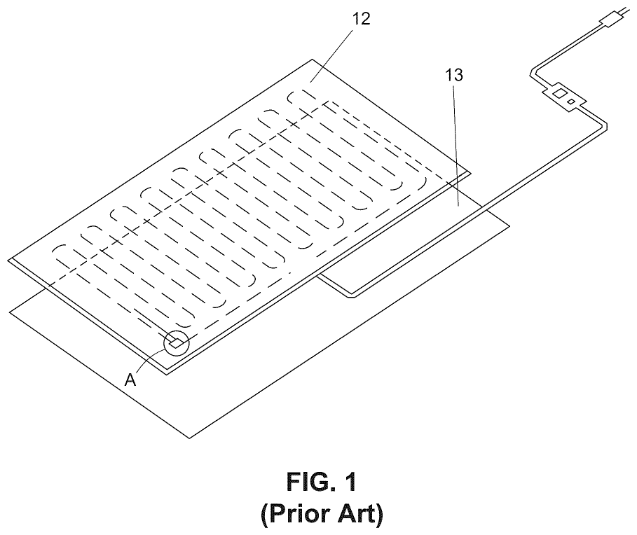

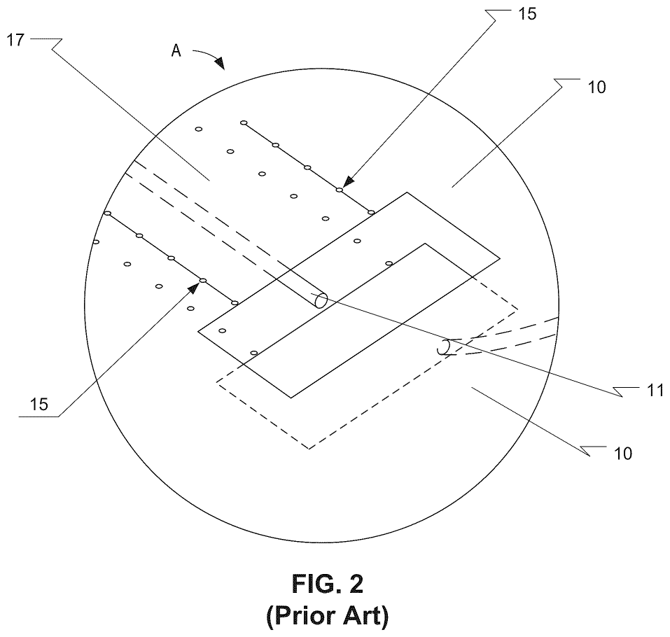

A known structure for fixing an electric heating wire of an electric heating product is illustrated in FIGS. 1 and 2. In this known fixing structure, a knotting phenomenon of the electric heating wire easily occurs after wearing of the electric heating product for a period of time or after water washing, and consequently, the manufacturer and operator may undertake high return rates and high production and service costs. As shown in FIGS. 1 and 2, a known structure for fixing an electric heating wire 11 includes upper and lower substrates 10. Multiple groups of parallel seam quilting lines 15 are disposed on the upper and lower substrates 10 according to a wire distribution path of the electric heating wire 11. Each group of seam quilting lines 15 includes two parallel straight suturing lines. A passage 17 through which the electric heating wire 11 passes is formed between each group of seam quilting lines 15. The electric heating wire 11 passes through the passage 17 in a meandering manner and is fixed between the two substrates 10 in a penetrating manner; that is, the electric heating wire 11 alternately passes through each passage 17 in a snake shape manner and is distributed between the two substrates 10. To fix the portions of the electric heating wire 11 positioned at the opening positions of two ends, the heating wire 11 is stuck by viscose paper, and fixation may be performed during sticking. However, a debonding phenomenon often occurs after water washing. Additionally, the viscose paper is manually stuck, so it may not be ensured that each passage 17 is firmly stuck. Rather, a sticking omission phenomenon may occur, and there is no constraint on the heating wire 11 after water washing. When passing through the adjacent passages 17 formed by two groups of seam quilting lines 15 in the known fixing manner of FIGS. 1 and 2, the electric heating wire 11 is in an arc-shaped wire distribution manner, and the arc-shaped wire distribution portion has high processing difficulty, and cannot be sutured in a seam quilting manner, so the electric heating wire 11 is practically in free transition in this portion. Thus, there is no fixing structure for fixing the electric heating wire 11 in this portion. To realize convenient wire penetration, a distance between two seam quilting lines 15 forming the passage 17 is large, and the degree of freedom of the electric heating wire 11 in the passage 17 is high. Therefore, under a non-static clothing use or washing condition, the electric heating wire 11 may move and an arc-shaped section between the two adjacent passages 17 may not be maintained at an expected path. As a result, the wire 11 is at one end is long and short at the other end. The end with the longer wire is easily knotted in a non-static state. The end with the shorter wire may cause substrate gathering and folds may be generated. Moreover, the width of the passage 17 is greater than the diameter width of the electric heating wire 11 and the electric heating wire 11 in the passage 17 may be easily knotted in the moving process. The electric heating product is in an abnormal use state after the knotting of the electric heating wire 11, and in the abnormal use state, the product may generate various abnormal conditions. For instance, the product may easily become too hot and burn a user. Also, use of the electric heating product under the abnormal condition may cause circuit abnormalities, may result in the product being burnt, may cause fire hazards, may cause personnel and property losses, and may cause product self-destruction scrapping. Heating wire knotting is a great risk point of an electric heating product. If knotting of the electric heating product occurs, the electric heating product may be scrapped, and a high return rate is caused; the return rate for this reason accounts for 4% to 5% of the total return rate of the product. Therefore, manufacturers try to avoid electric heating wire knotting.

Additionally, when the known fixing structure of FIGS. 1 and 2 is used, the seam quilting line setting and the wire penetration are separately completed in two different working procedures. Generally, the wire is penetrated manually. Some manufacturers use automatic threading machines for wire penetration, however, the two working procedures cannot be connected in an automatic manner, so that the full automation of the electric heating wire fixation cannot be realized, and the production efficiency in the whole industry is low. It is a bottleneck of this industry that the full automation of wire penetration cannot be realized. Recognizing that the problem that the automatic wire distribution cannot be realized, the Electric Heating Covering Blanket and Electric Heating Padded Blanket Committee of China Household Electrical Appliances Association proposed an industry task in October 2023. An electric heating covering blanket and electric heating padded blanket automatic wire distribution technical research and development group was established, being led by the Household Appliance Association, to research and develop new products to improve the automation level and put forward the electric heating composite and adhesive composite research and development ideas, but after the practice for one year, the effects were not obvious. This problem was recorded in 2024 meeting summary of China Household Electrical Appliances Association (China Household Electrical Appliances Association [2024] No. 24).

Disclosed herein are example electric heating products, example structures, and example methods for fixing an electric heating wire of an electric heating product to address technical problems that may easily cause heating wire knotting and that may prevent realization of automatic wire distribution. In examples disclosed herein, a structure for fixing an electric heating wire includes a wrapping and suturing strip/belt and suturing lines. Two ends of the wrapping and suturing strip/belt in a width direction form wrapping wings. The two wrapping wings are in opposite arrangement to form a passage accommodating the electric heating wire, and the suturing lines are disposed in overlapping portions of the two wrapping wings in a length direction of the wrapping and suturing strip/belt. Further, the suturing lines are configured to suture and connect the two wrapping wings in an overlapped arrangement with an electric heating product body for fixing the electric heating wire. In some examples, the quantity of the suturing lines is one or more. In some examples in which the quantity of the suturing lines is two or more, the suturing lines are in parallel arrangement. In some examples, the wrapping and suturing strip/belt is an edge covering cloth strip. In some examples, the passage is a complete notch-free passage in a length direction. In some examples, the electric heating wire is tightly wrapped by the wrapping and suturing strip/belt.

An example electric heating product includes an electric heating product body. The electric heating product body includes at least a surface layer and/or at least a substrate. The electric heating wire is fixed onto the heating product body through a fixing structure, where the fixing structure is according to any one of above-mentioned structures. The wrapping and suturing strip/belt is fixedly connected to the surface layer and/or the substrate through suturing lines, and the electric heating wire is wrapped in the passage and penetrates through the passage for the whole length.

In some examples, the example electric heating product includes a first surface layer, a second surface layer and a substrate. The substrate is clamped between the first surface layer and the second surface layer, and the electric heating wire is fixedly connected to the substrate through the fixing structure.

In some examples, the electric heating product further includes a junction device fixedly disposed on the electric heating product body, and two ends of the electric heating wire are respectively connected to positive and negative electrodes of the junction device.

In some examples, the electric heating wire is integrally distributed or regionally distributed on the substrate or surface layer, and/or a wire distribution path of the electric heating wire is arranged as multiple sections of parallel straight lines in end-to-end connection, and the straight lines being in end-to-end connection through arc lines.

In some examples, the first surface layer and the second surface layer are respectively made of one of lint, linen or warp and weft woven cloth, and/or the substrate and the wrapping and suturing strip/belt are made of one of non-woven fabrics, polyester fabrics or polyester-mixed cotton cloth; and/or the electric heating product is an electric heating clothing product, and the electric heating clothing product is any one of an electric heating covering blanket, an electric heating padded blanket, an electric heating rug, electric heating thermal underwear, an electric heating thermal jacket and electric heating thermal trousers; or the electric heating product is an electric heating thermal product, and the electric heating thermal product is any one of an electric heating mattress, an electric heating pad, an electric heating covering blanket and an electric heating padded blanket; or the electric heating product is an electric heating outdoor product, and the electric heating outdoor product is any one of an electric heating thermal tent and an electric heating simple shed.

In some examples, the junction device is connected to a power plug through a power supply wire, and a controller is disposed on the power supply wire.

An example method disclosed herein for fixing an electric heating wire includes: setting an electric heating wire and a wrapping and suturing strip/belt in the same direction in a length direction, folding two ends of the wrapping and suturing strip/belt in a width direction so that the two ends are overlapped to form wrapping wings for wrapping the electric heating wire, suturing and fixing the two wrapping wings of the wrapping and suturing strip/belt wrapping the electric heating wire through suturing lines so that the electric heating wire is positioned in a passage formed by the two wrapping wings, and then, fixedly installing the wrapping and suturing strip/belt wrapping the electric heating wire onto a substrate and/or surface layer of an electric heating product through the wrapping wings; or setting the electric heating wire and the wrapping and suturing strip/belt in the same direction in a length direction, folding two ends of the wrapping and suturing strips/belts in a width direction so that the two ends are overlapped to form wrapping wings wrapping the electric heating wire, suturing and fixing the two wrapping wings of the wrapping and suturing strip/belt wrapping the electric heating wire with a substrate or surface layer of an electric heating product through suturing lines so that the electric heating wire is positioned in a passage formed by the two wrapping wings, and fixing the electric heating wire onto the substrate and/or surface layer.

In some examples, two ends of the electric heating wire are fixedly connected to the substrate and/or surface layer through a junction box.

Examples disclosed herein provide the following beneficial effects. When the example structures and methods for fixing an electric heating wire according to the present disclosure are used, the electric heating wire is wrapped in the wrapping and suturing strip/belt in the length direction of the wrapping and suturing strip/belt through the wrapping and suturing strip/belt. The wrapping and suturing strip/belt wraps the electric heating wire for the whole length. The suturing lines are disposed on opposite sides of the two wrapping wings so that the wrapping and suturing strip/belt forms a passage accommodating the electric heating wire. The whole electric heating wire is fixed by the wrapping and suturing strip/belt, the whole of the electric heating wire may be fixed onto the heating product body as long as the wrapping and suturing strip/belt is fixed onto the surface layer or substrate of the electric heating product, and the fixation is firm and reliable. Accordingly, the suturing lines are formed in one side opening positions formed by the two wrapping wings. The suturing lines are positioned at one side of the electric heating wire and the electric heating wire may be fixed onto the heating product body by suturing the wrapping and suturing strip/belt onto the heating product body and wrapping the electric heating wire at the same time. Therefore, a process step of penetrating the heating wire is omitted, and processing operations are reduced. As a result, automatic fixation of the electric heating wire may be realized. Thus, the production efficiency is greatly improved, the technical problems of low electric heating wire penetration efficiency and non-automation that puzzled the industry for a long time are solved, and significant technical effects are achieved. The fixing structure according to the present disclosure may be directly fixed onto the substrate or may be connected to the substrate and then connected to the surface layer, or the surface layer and the substrate may be sutured and fixed together. Accordingly, adaptability is high, different electric heating wire fixing manners may be adopted according to different requirements, and electric heating wire fixing automation can be achieved without the use of specialized equipment.

In an example electric heating product using the structure of the present disclosure, the electric heating wire is fixed onto the heating product body through a fixing structure formed by the wrapping and suturing strip/belt and the suturing lines, in a connecting range with the heating product body. The fixation between the fixing structure and the heating product body is the fixation along the whole length of the electric heating wire, and the electric heating wire is completely fixed onto the heating product body, so that the heating product is integrated with the heating product body without staggering under conditions of kneading, rolling or washing, and, thus, knotting does not occur. When the electric heating wire is fixed onto the heating product body, the suturing lines are only disposed at one side of the electric heating wire, a wire distribution path of the suturing lines is not limited, and the suturing line distribution may be completed in one step through mechanical processing, so the processing difficulty is greatly reduced, and the production efficiency is improved. The electric heating wire may be installed onto the surface layer or the substrate according to the requirement of the electric heating product to meet different requirements of heating products.

When the example method and structure for fixing a heating wire of the present disclosure are used for fixing the electric heating wire and the electric heating product, the whole electric heating wire is fixed in a specified position through the wrapping and suturing strip/belt and the suturing lines, and regular and ordered distribution may be realized, so that the processing of a product is unified, and it is favorable for product appearance quality and suturing quality control. In a known method for fixing a heating wire by a seam quilting method, the electric heating wire in a passage with a certain width, and the heating wire is only clamped between two seam quilting lines instead of being fixed and, thus, is easily displaced. As compared to known methods, the example methods and the example fixing structures disclosed herein have the advantages that the heating wire is fixed into the wrapping and suturing strip/belt, two ends of the heating wire are fixed through the wrapping and suturing strip/belt and the suturing lines, and the whole of the heating wire may be fixed in a specified position, so that a phenomenon in which the heating wire moves out from open opening positions at two ends of each passage may be avoided. Therefore, the occurrence of a heating wire knotting phenomenon may be avoided from structural design.

In order that the objectives, technical solutions and advantages of the disclosure will become more apparent, the disclosure will be described in more detail with reference to the drawings and examples hereafter. It should be understood that the specific examples disclosed herein are provided for describing the disclosure and not intended to limit the disclosure.

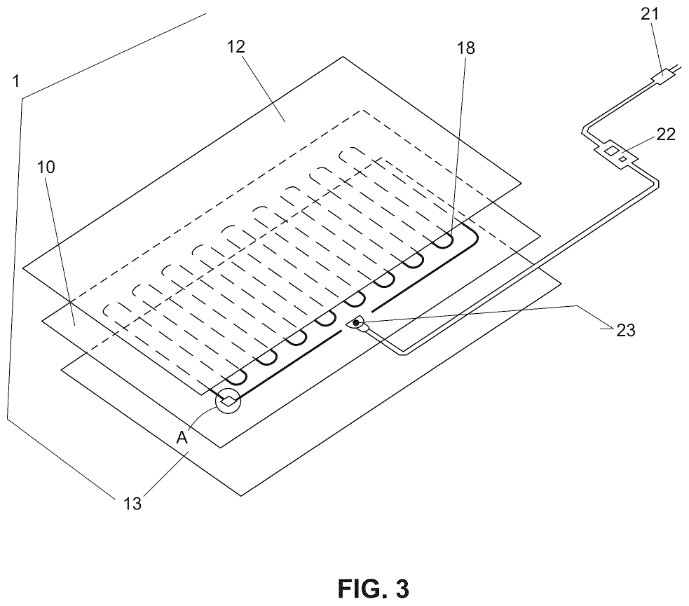

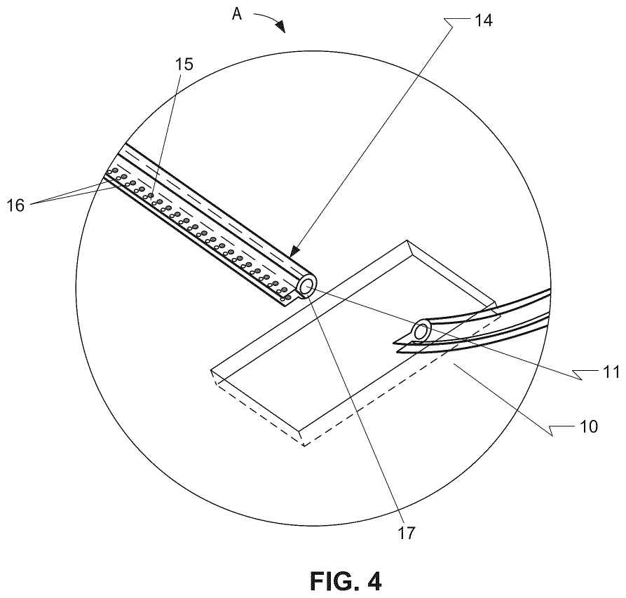

As shown in FIG. 3 and FIG. 4, an example electric heating product according to teachings of the present disclosure includes an electric heating product body 1 and an electric heating wire 11. The electric heating product body 1 may only include a surface layer 12, 13, may only include a substrate 10, or may include both the surface layer 12, 13 and the substrate 10. The electric heating wire 11 is fixedly disposed on the electric heating product body 1 through a fixing structure 18. In examples in which the electric heating product body 1 only includes the surface layer 12, 13, the electric heating wire 11 is fixedly disposed on the surface layer 12, 13 through the fixing structure 18. In examples in which the electric heating product body 1 only includes the substrate 10, the electric heating wire 11 is fixedly disposed on the substrate 10 through the fixing structure 18. In examples in which the electric heating product body 1 includes the surface layer 12, 13 and the substrate 10, the electric heating wire 11 is fixedly disposed on the substrate 10 through the fixing structure 18 and the substrate 10 is fixedly connected to the surface layer 12, 13. The electric heating wire 11 may be fixedly disposed on both the substrate 10 and the surface layer 12, 13, and the electric heating wire 11, the substrate 10, and the surface layer 12, 13 are integrally connected.

In some examples, the surface layer includes a first surface layer 12 and a second surface layer 13. The substrate 10 is clamped between the first surface layer 12 and the second surface layer 13, and is fixedly connected to the first surface layer 12 and the second surface layer 13.

In some examples, the fixing structure 18 includes a wrapping and suturing strip/belt 14 wrapping the electric heating wire 11 and suturing lines 15 for suturing an opening side of the wrapping and suturing strip/belt 14 onto the electric heating product body 1. The wrapping and suturing strip/belt 14 wraps the electric heating wire 11 in a manner that the length direction of the wrapping and suturing strip/belt 14 is in the same direction as the length direction of the electric heating wire 11. Two wrapping wings 16 are formed in the width direction of the wrapping and suturing strip/belt 14. The two wrapping wings 16 are in overlapped arrangement. The two wrapping wings 16 and the electric heating product body 1 are sutured together through the suturing lines 15. In some examples, the two wrapping wings 16 wrapping the wrapping and suturing strip/belt 14 of the electric heating wire 11 are sutured through the suturing lines 15 to clamp the electric heating wire 11. Then, the electric heating wire 11 is fixed onto an inner side and/or the outer side of the electric heating product 1 through the suturing lines 15 via the two wrapping wings 16. In some examples, the wrapping and suturing strip/belt 14 wrapping the electric heating wire 11 is directly sutured and fixed onto the inner side and/or outer side of the electric heating product body 1 through the suturing lines 15 and the two wrapping wings 16. By using such a fixing manner, the electric heating wire 11 penetrates into the wrapping passage defined by the two wrapping wings 16 of the wrapping and suturing strip/belt 14 for the whole length, and additionally, only positions of two wrapping wings 16 at a single side of the electric heating wire 11 need to be fixed, so that the electric heating wire 11 may be wrapped during wire distribution, single-line or multi-line suturing may be performed by using an ordinary suturing machine, and wire distribution automation is realized. Wrapping and suturing may be realized by using specifical wire wrapping and suturing equipment, and the production efficiency may be further improved. Additionally, the electric heating wire 11 is fixed for the whole length and is wrapped by the wrapping and suturing strip/belt 14. In some examples, the two ends of the electric heating wire 11 are fixedly connected to a junction box, and the junction box is fixed onto the electric heating product body 1, so that the electric heating wire 11 moves together with the electric heating product body 1 to which the electric heating wire is fixed, and cannot jump in the wrapping and suturing passage 17, and the occurrence of an electric heating wire knotting phenomenon may be avoided. Additionally, the wire distribution path of the electric heating wire 11 is not limited. For example, the wire distribution may be performed according to a wire distribution path and the distribution is flexible. Also, a wire penetrating operation is omitted, the production efficiency is greatly improved, and a technical problem puzzling the industry for a long time is solved.

In some examples, the electric heating wire 11 on the electric heating product body 1 may be integrally distributed or regionally distributed. In examples in which the electric heating wire 11 is regionally distributed, the heating temperatures of the electric heating wire 11 in different regions may be independently controlled to adapt to different requirements.

In some examples, the first surface layer 12 and the second surface layer 13 may be respectively made of one of lint, linen, or warp and weft woven cloth.

In some examples, the wrapping and suturing strip/belt 14 may be an edge covering cloth strip or an edge covering strip. The suturing line(s) 15 may be a single suturing line or multiple parallel suturing lines.

In some examples, the electric heating product 1 may be a clothing product, such as an electric heating rug, electric heating thermal underwear, a jacket and electric heating thermal trousers, or may be a thermal product, such as an electric heating mattress, an electric heating covering blanket and an electric heating padded blanket, or may be made into an outdoor product, such as an electric heating thermal tent.

The substrate 10 may be made of non-woven fabrics, and the non-woven fabrics are light and soft, and are suitable for clothing use. The substrate 10 may also be made of polyester fabrics or polyester-mixed cotton cloth. The wrapping and suturing strip/belt 14 is preferably made of non-woven fabrics, polyester fabrics or polyester-mixed cotton cloth.

The fixing structure 18 of the present disclosure may be manually sutured and may be sutured through equipment. Through multi-line simultaneous suturing by equipment, the efficiency may be improved.

In some examples, the electric heating product further includes a junction device. The junction device includes a junction box 23 fixed onto the electric heating product body 1 and a power supply wire connected to the junction box 23. A power plug 21 and a controller 22 are disposed on the power supply wire and are respectively configured to realize power supply switching and heating gear adjustment, as shown in FIG. 3.

The example fixing structure 18 of the present disclosure fixes the electric heating wire. The wire distribution path of the electric heating wire 11 may be in a circular shape, and may be in a meandering snake shape, or a plane spiral shape, or a concentric square shape, etc.

The examples of the present disclosure are intended to cover all such substitutions, modifications and variations that fall within the broad scope of the claims. Therefore, any omission, modification, equivalent substitution, improvement, etc. made within the spirit and principles of the example of the disclosure shall be included in the protection scope of the disclosure.

### EXAMPLES AND COMPARATIVE EXAMPLES

In Example 1, an example electric heating product is an electric heating rug and includes a first surface layer and a second surface layer, a substrate is fixedly disposed between the first surface layer and the second surface layer. In the example, a specification size is 50 inches×60 inches, a shell fabric of the surface layers is flannel and Shu velveteen, a shell fabric of the substrate is non-woven fabrics, a model of the heating wire is 202005025, and a stitch density is 5.5 mm. A wire distribution path is as shown in FIG. 1, and a meandering snake-shaped structure formed by straight lines in end-to-end connection via arcs is used. A washing device is Whirlpool 3LWTW4840YW1.

A fixing structure is the fixing structure 18 of the present disclosure and is sutured with the substrate by a single line after being wrapped by an edge covering cloth strip, and the edge covering cloth strip made of non-woven fabrics is used.

In Example 2, a shell fabric of the surface layer is irreversible flannelette, a shell fabric of the substrates and a material of a wrapping and suturing strip/belt are polyester cloth, and others are the same as those in Example 1.

In Example 3, a shell fabric of the surface layer is coral fleece, a shell fabric of the substrates and a material of a wrapping and suturing strip/belt are polyester-mixed cotton cloth, and others are the same as those in Example 1.

In Comparative Example 1, a fixing structure includes two layers of substrates, a heating wire passage is sutured on the two layers of the substrates through seam quilting, the heating wire is penetrated into the heating wire passage, and other indexes, such as a first surface layer, a second surface layer, a heating wire model and a wire distribution path are the same as those in Example 1.

In Comparative Example 2, a shell fabric of a surface layer and a shell fabric of substrates are the same as those in Example 2, and others are the same as those in Comparative Example 1.

In Comparative Example 3, a shell fabric of a surface layer and a shell fabric of substrates are the same as those in Embodiment 3, and others are the same as those in Comparative Example 1.

Washing comparison experiments were performed on electric heating products in Examples 1 to 3 and Comparative Examples 1 to 3. An experiment device was Whirlpool 3LWTW4840YW1, a test standard was UL964, and machine washing tests were performed according to the following method:

A washing machine was fully filled with 65° C. warm water, a half cup of washing powder or mild soap flakes were added, and stirring was performed for dissolution. One product was put into the washing machine to be soaked for 5 minutes, slow stirring was performed for 2 minutes, and spin-drying was performed at a normal speed. The washing machine was continuously filled with cold water for rinsing, stirring was performed for 1 minute, and rotation was performed at a normal speed. After completion, rinsing was repeated once. High-temperature drying was performed in an automatic drying machine for 5 minutes. Finally, the product was spread out to present an original shape and size to reach a completely dry state. The sampling quantity of rugs in each of Examples 1 to 3 was respectively 5, the sampling quantity of rugs in each of Comparative Examples 1 to 3 was respectively 5, each rug was repeatedly washed for 30 times, and the appearance was observed after washing. The test results were as follows:

TABLE 1
Test Result Comparison Table

| | | | | | Electric heating | Whether a |
|---|---|---|---|---|---|---|
| | | | | | wire goes out and | product |
| | | | | Heating | is gathered to | function is |
| | | | Number | wire | open positions at | normal or not |
| ITEMS | | Knotting | of knots | bending | two ends of passage | after washing |
| Example 1 | 1 | No | 0 | No | No | Normal |
| | 2 | No | 0 | No | No | Normal |
| | 3 | No | 0 | No | No | Normal |
| | 4 | No | 0 | No | No | Normal |
| | 5 | No | 0 | No | No | Normal |
| Example 2 | 1 | No | 0 | No | No | Normal |
| | 2 | No | 0 | No | No | Normal |
| | 3 | No | 0 | No | No | Normal |
| | 4 | No | 0 | No | No | Normal |
| | 5 | No | 0 | No | No | Normal |
| Example 3 | 1 | No | 0 | No | No | Normal |
| | 2 | No | 0 | No | No | Normal |
| | 3 | No | 0 | No | No | Normal |
| | 4 | No | 0 | No | No | Normal |
| | 5 | No | 0 | No | No | Normal |
| Comparative | 1 | Yes | 1 | Yes | Yes | Normal |
| Example 1 | 2 | Yes | 2 | Yes | No | Normal |
| | 3 | No | 0 | Yes | No | Normal |
| | 4 | Yes | 2 | Yes | No | Normal |
| | 5 | Yes | 2 | Yes | No | Normal |
| Comparative | 1 | No | 0 | Yes | No | Normal |
| Example 2 | 2 | No | 0 | Yes | No | Normal |
| | 3 | No | 0 | Yes | No | Normal |
| | 4 | Yes | 1 | Yes | No | Normal |
| | 5 | No | 0 | Yes | No | Normal |
| Comparative | 1 | Yes | 3 | Yes | Yes | Normal |
| Example 3 | 2 | Yes | 3 | Yes | No | Normal |
| | 3 | Yes | 2 | Yes | No | Normal |
| | 4 | Yes | 3 | Yes | No | Normal |
| | 5 | Yes | 3 | Yes | Yes | Normal |

In conclusion, no matter which kind of materials was used as the surface layer material, the substrate material and the wrapping and suturing strip/belt material of the electric heating product, when the fixing structure of the present disclosure was used for fixing the electric heating wire, a knotting phenomenon of the electric heating wire did not occur, and a phenomenon that the electric heating wire moved out of the passage and bent did not occur. However, according to Comparative Examples 1 to 3, the knotting rate of Comparative Example 1 was 80%, the knotting rate of Comparative Example 2 was 20%, and the knotting rate of Comparative Example 3 was 100%. The ratios of a phenomenon that the electric heating wire moved out of the passage were respectively 20%, 0 and 40%. The functions were generally normal through test immediately after washing.

From the example test data, it can be seen that if a known shell fabric seam quilting and heating wire penetrating process is used, the safety of a blanket is greatly related to the shell fabric. Some shell fabrics have high quality, and some have poor quality, but a knotting phenomenon easily occurs. When the example structures and methods for fixing a heating wire of the present disclosure are used for fixing the heating wire, the fixing effect is not influenced by the type of the shell fabrics, more choices are provided for customers, and safety is guaranteed.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

In the descriptions of the disclosure, it should be understood that the terms “upper,”, “lower,” “front,” “rear,” “inner,” “outer,” etc. indicating the orientation or the positional relationship are based on the orientation or the positional relationship shown in the drawings, are only for convenience of describing the disclosure and simplifying the descriptions, are not intended to indicate or imply that the referenced apparatus or element must have a particular orientation, be constructed and operated in a particular orientation, and therefore cannot be understood as a limitation of the disclosure.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

Example apparatus and methods for fixing an electric heating wire of an electric heating product are disclosed herein. Further examples and combinations thereof include the following:

Example 1 includes an electric heating product comprising a body; an electric heating wire; a belt defining a passage; and suturing lines, the electric heating wire wrapped in the passage via the suturing lines, the suturing lines coupling the belt to the body.

Example 2 includes the electric heating product of example 1, wherein the body includes at least one of a surface layer or a substrate, the belt coupled to the one or more of the surface layer or the substrate via the suturing lines.

Example 3 includes the electric heating product of examples 1 or 2, wherein the electric heating wire penetrates a length of the passage.

Example 4 includes the electric heating product of any of examples 1-3, wherein the body includes a first surface layer, a second surface layer, and a substrate, the substrate is between the first surface layer and the second surface layer, and the electric heating wire is coupled to the substrate via the belt.

Example 5 includes the electric heating product of any of examples 1-4, wherein the belt is made of one of non-woven fabrics, polyester fabrics, or polyester-mixed cotton cloth.

Example 6 includes the electric heating product of any of examples 1-5, further including a junction device, wherein two ends of the electric heating wire are respectively connected to positive and negative electrodes of the junction device.

Example 7 includes the electric heating product of any of examples 1-6, wherein the junction device is coupled to the body.

Example 8 includes the electric heating product of any of examples 1-7, wherein the junction device is operatively coupled to a power plug via a power supply wire.

Example 9 includes the electric heating product of any of examples 1-8, wherein the passage defines a wire distribution path having a first parallel line, a second parallel line, and an arc between the first parallel line and the second parallel line.

Example 10 includes the electric heating product of any of examples 1-9, wherein the electric heating product is an electric heating clothing product.

Example 11 includes the electric heating product of any of examples 1-10, wherein the electric heating product is an electric heating rug.

Example 12 includes the electric heating product of any of examples 1-11, wherein the electric heating product is an electric heating mattress, an electric heating pad, an electric heating covering blanket, or an electric heating padded blanket.

Example 13 includes the electric heating product of any of examples 1-12, wherein the electric heating product is an electric heating thermal tent.

Example 14 includes an apparatus comprising a wrapping and suturing strip defining a passage to receive an electric heating wire, the wrapping and suturing strip including two wings; and suturing lines disposed in overlapping portions of the two wings of the wrapping and suturing strip to secure the electric heating wire in the passage.

Example 15 includes the apparatus of example 14, wherein the wrapping and suturing strip is coupled to a wearable heating electronic device via the suturing lines.

Example 16 includes the apparatus of examples 14 or 15, wherein the suturing lines are in parallel arrangement.

Example 17 includes the apparatus of any of examples 14-16, wherein the wrapping and suturing strip is a cloth strip.

Example 18 includes the apparatus of any of examples 14-17, wherein the passage defines at least a partially curved path for the electric heating wire.

Example 19 includes a method for fixing an electric heating wire, the method comprising setting the electric heating wire and a wrapping and suturing strip in a same direction in a length direction; folding two ends of the wrapping and suturing strip in a width direction so that the two ends of the wrapping and suturing strip are overlapped to form wings for wrapping the electric heating wire; suturing the two wings of the wrapping and suturing strip so that the electric heating wire is positioned in a passage formed by the two wings; and coupling the wrapping and suturing strip to one or more of a substrate or a surface layer of an electric heating product.

Example 20 includes the method of example 19, further including coupling two ends of the electric heating wire to a junction box.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An electric heating product comprising:
a body;
an electric heating wire;
a belt defining a passage; and
suturing lines, the electric heating wire wrapped in the passage via the suturing lines, the suturing lines coupling the belt to the body.

2. The electric heating product of claim 1, wherein the body includes at least one of a surface layer or a substrate, the belt coupled to the one or more of the surface layer or the substrate via the suturing lines.

3. The electric heating product of claim 1, wherein the electric heating wire penetrates a length of the passage.

4. The electric heating product of claim 1, wherein the body includes a first surface layer, a second surface layer, and a substrate, the substrate is between the first surface layer and the second surface layer, and the electric heating wire is coupled to the substrate via the belt.

5. The electric heating product of claim 1, wherein the belt is made of one of non-woven fabrics, polyester fabrics, or polyester-mixed cotton cloth.

6. The electric heating product of claim 1, further including a junction device, wherein two ends of the electric heating wire are respectively connected to positive and negative electrodes of the junction device.

7. The electric heating product of claim 6, wherein the junction device is coupled to the body.

8. The electric heating product of claim 6, wherein the junction device is operatively coupled to a power plug via a power supply wire.

9. The electric heating product of claim 1, wherein the passage defines a wire distribution path having a first parallel line, a second parallel line, and an arc between the first parallel line and the second parallel line.

10. The electric heating product of claim 1, wherein the electric heating product is an electric heating clothing product.

11. The electric heating product of claim 1, wherein the electric heating product is an electric heating rug.

12. The electric heating product of claim 1, wherein the electric heating product is an electric heating mattress, an electric heating pad, an electric heating covering blanket, or an electric heating padded blanket.

13. The electric heating product of claim 1, wherein the electric heating product is an electric heating thermal tent.

14. An apparatus comprising:
a wrapping and suturing strip defining a passage to receive an electric heating wire, the wrapping and suturing strip including two wings; and
suturing lines disposed in overlapping portions of the two wings of the wrapping and suturing strip to secure the electric heating wire in the passage.

15. The apparatus of claim 14, wherein the wrapping and suturing strip is coupled to a wearable heating electronic device via the suturing lines.

16. The apparatus of claim 14, wherein the suturing lines are in parallel arrangement.

17. The apparatus of claim 14, wherein the wrapping and suturing strip is a cloth strip.

18. The apparatus of claim 14, wherein the passage defines at least a partially curved path for the electric heating wire.

19. A method for fixing an electric heating wire, the method comprising:
setting the electric heating wire and a wrapping and suturing strip in a same direction in a length direction;
folding two ends of the wrapping and suturing strip in a width direction so that the two ends of the wrapping and suturing strip are overlapped to form wings for wrapping the electric heating wire;
suturing the two wings of the wrapping and suturing strip so that the electric heating wire is positioned in a passage formed by the two wings; and
coupling the wrapping and suturing strip to one or more of a substrate or a surface layer of an electric heating product.

20. The method of claim 19, further including coupling two ends of the electric heating wire to a junction box.
